(19) United States
(12) Patent Application Publication
(10) Pub. No.: US 2025/0349083 A1
(43) Pub. Date: Nov. 13, 2025

(54) Interactive Augmented Reality Marketplace Assistant

(71) Applicant: eBay Inc., San Jose, CA (US)

(72) Inventor: Andrew Chalkley, Milwaukie, OR (US)

(73) Assignee: eBay Inc., San Jose, CA (US)

(21) Appl. No.: 18/656,811

(22) Filed: May 7, 2024

(51) Int. Cl. G06T 19/00; G06Q 30/0601; G06T 19/20; G06V 40/20

(52) U.S. Cl. CPC G06T 19/006; G06Q 30/0643; G06T 19/20; G06V 40/28; G06T 2219/2004

(57) ABSTRACT

Interactive Augmented Reality Assistants are described. An example computing device captures image data of a physical environment for displaying an augmented reality (AR) of the physical environment on a display as an AR environment. The computing device identifies one or more physical items in the physical environment based at least in part on the image data. The computing device communicates with one or more listing servers over a network to identify one or more listed items related to the one or more physical items. The computing device renders a virtual object in the AR environment as an AR assistant for accessing the one or more listing servers. The computing device generates, in response to detecting a user interaction with the AR assistant in the AR environment, an output using information associated with the one or more listed items.

### BACKGROUND

Some computing applications enable a user to use devices associated with a three-dimensional (3D) environment. For example, virtualization systems may employ wearable devices or other types of electronic devices to present virtual content to a user, in an augmented reality (AR), virtual reality (VR), or extended reality (XR) environment, and in various real-world settings (e.g., home or office or store or any other indoor or outdoor setting). Such virtualization systems are typically employed in certain computing applications such as gaming or entertainment applications. However, many other computing applications typically rely on devices associated with a two-dimensional (2D) environment.

For example, conventionally, a user can view an item of interest at a web site or other online platform using a display screen associated with a 2D environment. For instance, the user may be researching information about an item or searching for the item in an online item depository or other item listing service (e.g., art gallery, document gallery, fashion gallery, publishing platform, social platform, shopping website, online marketplace, etc.). In these types of scenarios, the user experience is most likely limited to a typical online experience. In other words, these types of scenarios typically lack the ability for personal interactions (e.g., a face-to-face conversation) between the user and another person with knowledge of the item (e.g., employee of a gallery or store) or with knowledge of a context of the user's interest (e.g., a friend or family member or neighbor or co-worker). Online services also typically provide limited options or tools (e.g., text search) for a user to describe the information or item they are seeking. Accordingly, a user may spend a considerable amount of time trying to find or research an item online, without necessarily succeeding. This, in turn, can result in inefficient utilization of computing resources such as processing cycles, memory, and network bandwidth.

### SUMMARY

Within examples, a system is described that displays an augmented reality (AR) of a physical environment as an AR environment and that identifies physical items in the physical environment. To do so, the system captures image data of the physical environment and uses the captured image data to identify the physical items. The system also communicates with one or more item listing service providers to identify listed items that are related to the identified physical items. The system also renders an interactive AR assistant in the AR environment. The AR assistant is configured, for example, to facilitate access to the one or more item listing servers. In response to detecting a user interaction with the AR assistant in the AR environment, the system generates an output using information associated with the listed items which are related to the identified physical items.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. In some implementations, entities represented in the figures are indicative of one or more entities and thus reference is made interchangeably to single or plural forms of the entities in the discussion.

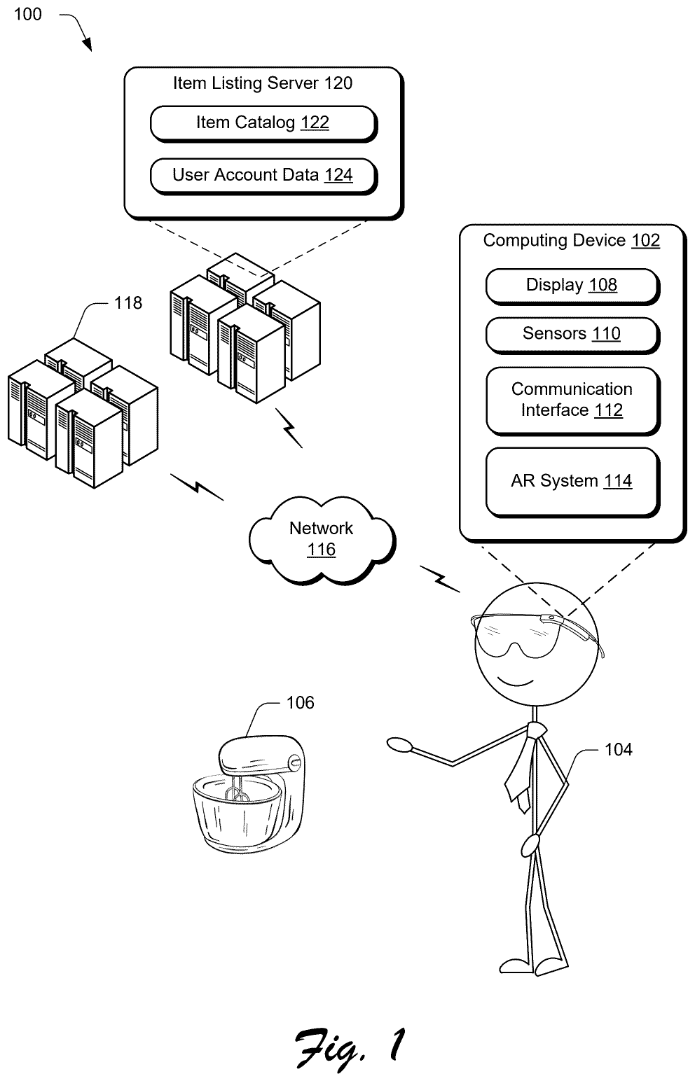

FIG. 1 is an illustration of an environment in an example implementation that is operable to employ an AR system to access an item listing server.

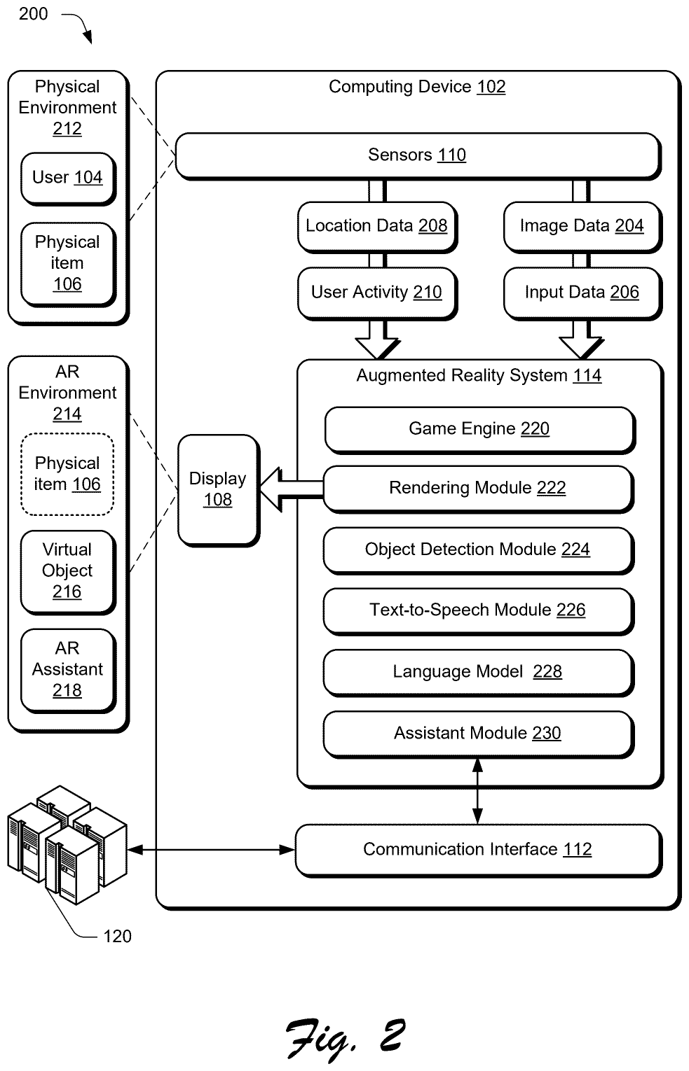

FIG. 2 depicts a system in an example implementation showing operation of the AR system of FIG. 1 in greater detail.

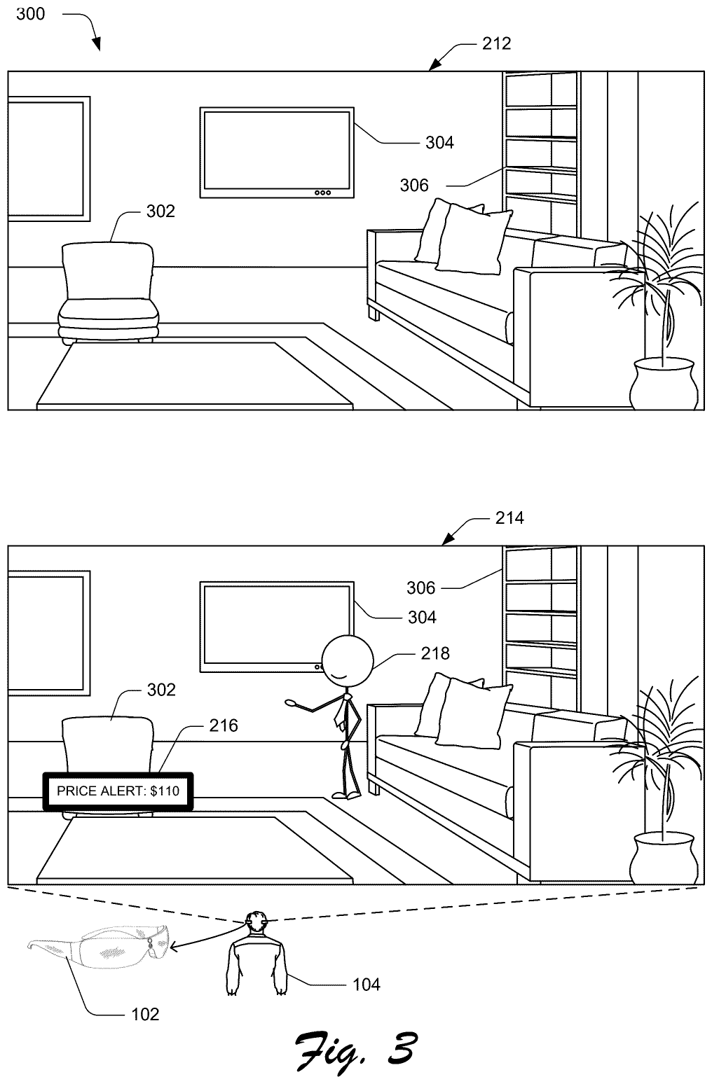

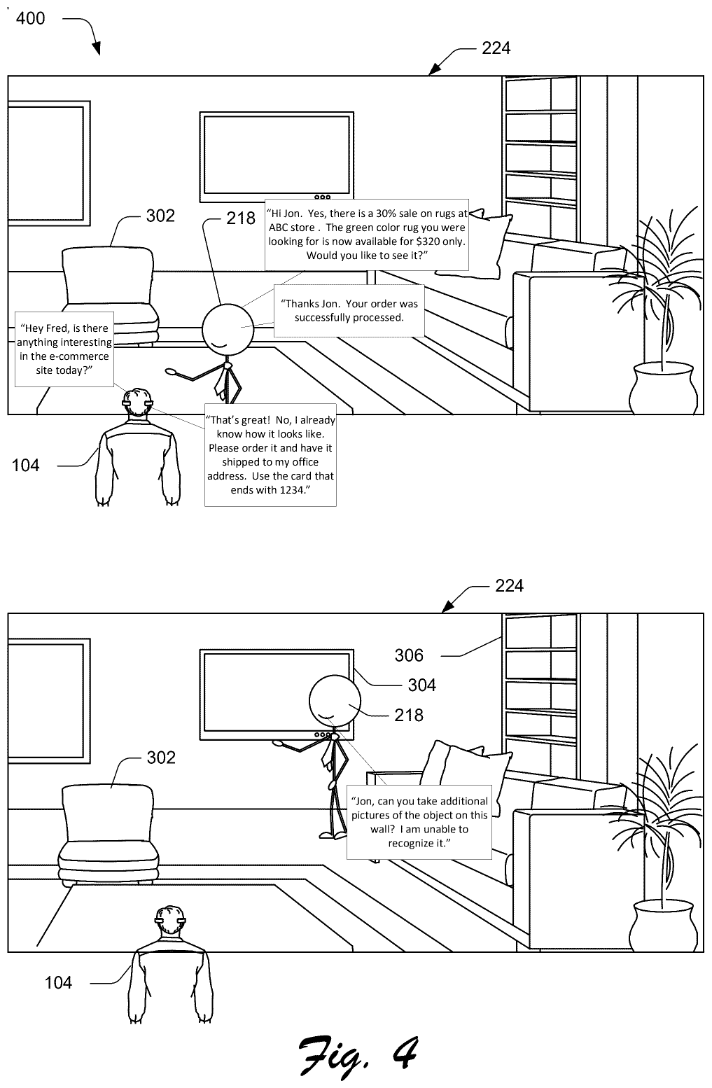

FIG. 3 and FIG. 4 depict examples of a physical environment for which the AR system of FIG. 1 is configured to display AR environments that employ an AR assistant to facilitate intuitive and seamless interactions between a user and one or more item listing service providers.

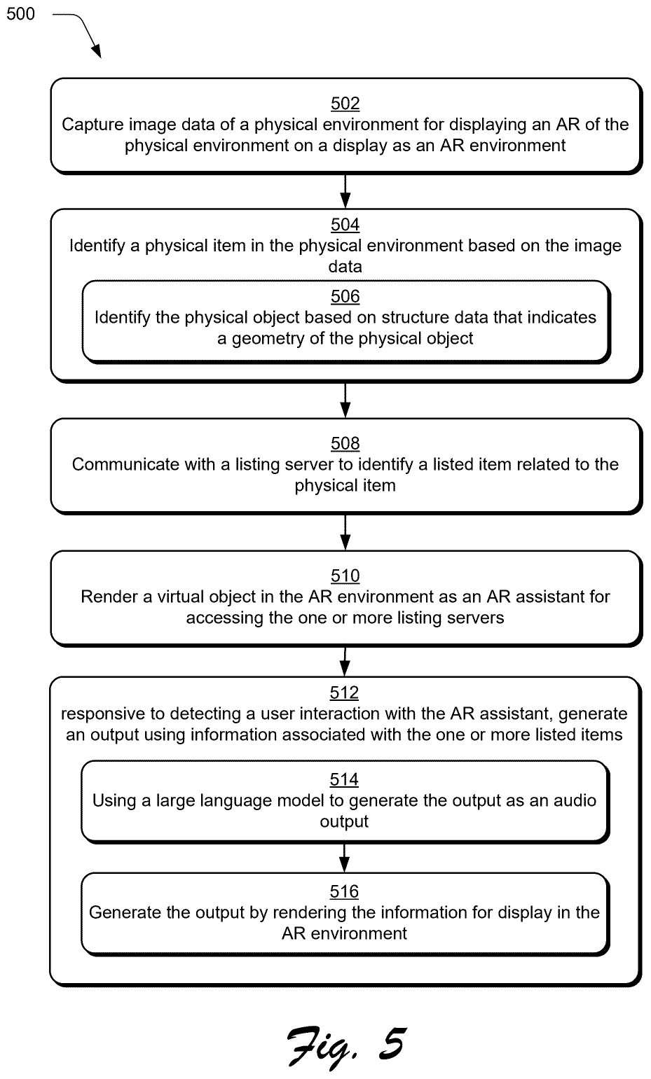

FIG. 5 is a flow diagram depicting a procedure in an example implementation of using an interactive AR assistant for accessing one or more item listing service providers.

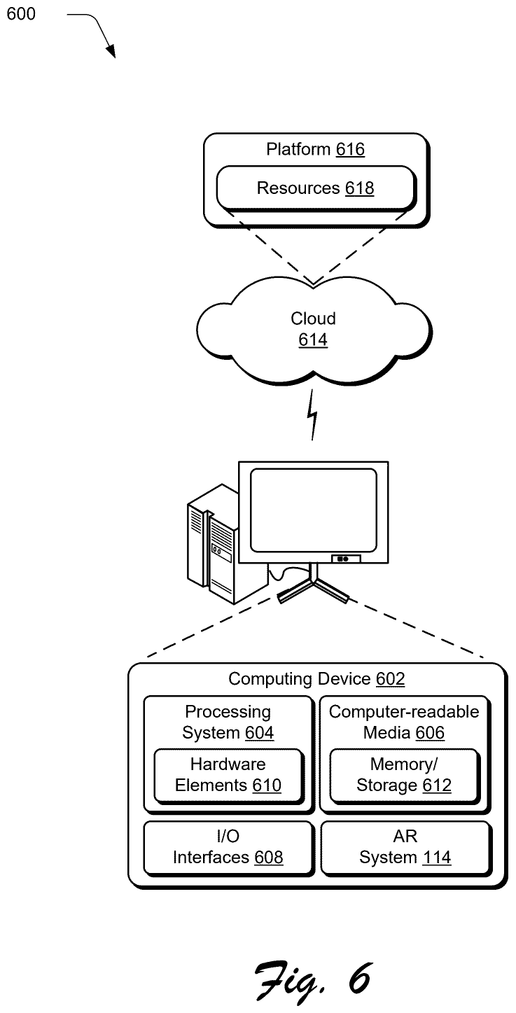

FIG. 6 illustrates an example system including various components of an example device to implement the techniques described with reference to FIGS. 1-6.

### DETAILED DESCRIPTION

### Overview

This Detailed Description describes technologies for rendering an interactive virtual assistant in an augmented reality (AR), virtual reality (VR), and/or extended reality (XR) environment of a user. The virtual or AR assistant enables the user to intuitively and seamlessly interact with an item listing providers, such as an item gallery platforms, online document repositories, online marketplaces, electronic commerce sites, and the like. To do so, in various examples, the AR assistant leverages a variety of technologies such as object recognition, text-to-speech synthesis, natural or large language models, game engines, and/or other computing technologies associated with AR, VR, and/or XR technologies to enable the user to describe the information they are seeking in a natural and intuitive manner and to receive the resulting output in a similarly natural and intuitive manner. Furthermore, in some examples, disclosed AR systems infer the context and/or intent of the user with respect to the item of interest to further improve the accuracy of the generated output based on recognition and/or location data. For example, the AR system is configured to identify physical objects in the physical environment of the user (e.g., furniture, electronics, etc.) and use this knowledge to provide information about listed items that the user is likely to be interested in. As discussed briefly above, the disclosed technologies improve computing efficiencies with respect to a wide variety of computing resources that would otherwise be consumed and/or utilized by improving human-computer interaction and by reducing the amount of processing cycles and storage required by previous solutions.

As described herein, the disclosed technologies provide a seamless transition from an online experience to a personal, interactive experience between a user and a virtual assistant. That is, a user can casually communicate with the virtual or AR assistant in a similar manner that the user would communicate with a real person and the AR assistant then uses contextual information such as the setting of user's physical environment (e.g., home, office, outdoor, etc.), items in that setting (e.g., electronics, accessories, etc.) to further enhance the accuracy and relevance of listed items obtained from the online listing service providers.

The described systems therefore provide a seamless, interactive, and improved user experience and system capabilities for navigating, searching, researching, and/or otherwise using online services such as online marketplaces, item listing platforms, online galleries, etc., in a more natural and intuitive manner. Advantageously, the disclosed systems also enable computer-automated services such as providing instant notifications when an opportunity to purchase or sell an item of interest to a specific user becomes available. Furthermore, the disclosed systems improve the reliability and computational efficiency of network-based service providers by reducing unnecessary and excessive computational resource consumption that result in unsatisfactory results.

In the following discussion, an example environment is described that is configured to employ the techniques described herein. Example procedures are also described that are configured for performance in the example environment as well as other environments. Consequently, performance of the example procedures is not limited to the example environment and the example environment is not limited to performance of the example procedures.

### Example Environment

FIG. 1 is an illustration of an example environment 100 in which an example implementation is operable to employ techniques described herein. The illustrated example environment 100 includes a computing device 102, which is configurable in a variety of manners.

The computing device 102, for example, is configurable as a desktop computer, a laptop computer, a mobile device (e.g., a handheld or wearable configuration like a tablet, mobile phone, smartwatch, headset, etc.), such as the headset worn by a user 104 in the illustrated example of FIG. 1, and so forth. Thus, the computing device 102 ranges from full resource devices with substantial memory and processor resources (e.g., personal computers, game consoles) to low-resource devices with limited memory and/or processing resources (e.g., mobile devices, wearable devices, etc.). Additionally, although a single computing device 102 is shown, the computing device 102 is representative of a plurality of different devices, such as a plurality of client computing devices associated with a plurality of users and/or multiple servers utilized to perform operations “over the cloud.”

In the illustrated example, the computing device 102 is configured as a headset, i.e., a wearable device. In examples, the wearable device 102 is operable as an XR, AR, or VR headset. For instance, in an AR headset configuration, the computing device 102 is configured to display to the user 104 an augmented reality of a physical environment of the user 104 as an augmented reality (AR) environment. The AR environment, for instance, is a view that includes real-world or physical items within a field-of-view of the user 104, such as physical item 106, in combination with one or more virtual objects (not shown), i.e., objects that do not actually exist in the real-world or physical environment of the user 104. A real-world or physical item 106 can be any type of item including, but not limited to, electronics, home goods, automobiles, automotive parts, clothing, musical instruments, art, jewelry, and so forth. A virtual item, on the other hand, can be any type of visual rendering displayable on the display 108 including, but not limited to, graphic user interface element, a graphic icon, a digital structure, a computer-generated drawing, a projected light pattern, cartoon character, and so forth.

To facilitate this, in the illustrated example, the computing device 102 includes a display 108, sensors 110, a communication interface 112, and an AR system 114.

The display 108 includes any type of display device, such as a light-emitting-diode (LED) display, a liquid crystal display (LCD), or a projector. In a first example, the display 108 includes an LED or LCD type of display that generates the AR view of the physical environment of the user 104 by combining a model (e.g., 3D model, 3D mesh, etc.) or image of physical objects like the physical item 106 as well as one or more virtual objects (not shown). In a second example, the display 108 includes a projection device configured to project light onto an inside of a transparent lens of the headset 102 so as to augment the view of the real-world or physical environment visible to the user 104 with one or more virtual objects (not shown). In this example, the physical item 106 is visible to the user 104 through the transparent lens and the one or more virtual objects are visible to the user due to the light from the projection device being reflected at the inner side of the transparent lens to the user's eye to simulate a combined presence of the virtual objects and the physical item 106 in a field-of-view of the user 104.

The sensors 110 include any type, number, or combination of sensors configurable to collect a variety of possible types of sensor measurements of a physical environment of the user 104, an object or surface in the physical environment, the user 104, the computing device 102, and/or any other type of measurable sensor data. In an example, the sensors 110 include a camera or other optical sensor configured to capture image data of the physical environment (e.g., a photograph of the field-of-view of the user 104 that shows the physical item 106). In an example, the sensors 110 include a microphone or other sound sensor configured to detect audio inputs from the user 104 and/or other sounds from the user 104 or other source in the environment of the user 104. In an example, the sensors 110 include various other possible sensors, such as any of a motion sensor, proximity sensor, LIDAR sensor, biological sensor (e.g., blood pressure sensor), or temperature sensor, among other possibilities.

The communication interface 112 includes any device configured to communicate data over network 116 between the computing device 102 and/or one or more other computing devices, such as any of remote servers 118 and/or 120. To that end, the communication interface 112 includes any combination of hardware and/or software components operable to perform wired or wireless communication over the network 116. For example, the communication interface 112 is operable to communicate according to various types of wired or wireless interface such as ethernet, Wi-Fi, radio access network (e.g., LTE, 5G, etc.), and so forth. To that end, the network 116 includes any type of wired or wireless network including, but not limited to, an ethernet network, a Wi-Fi network, a radio access network, and so forth.

The AR system 114 includes any combination of hardware and/or software components operable to perform the various functions of the present disclosure. In an example, the AR system 114 is configured to render an AR environment displayed to the user 104 via the display 108. For example, the AR system 114 renders one or more virtual objects and/or a representation of one or more real-world or physical objects. In examples, the AR system 114 is configured to render a virtual or AR assistant (not shown) in the AR environment viewable by the user 104. For example, the user 104 can indicate interest in an item by interacting with the AR assistant in the AR environment. For example, the AR assistant uses this information to identify one or more listed items (e.g., in the item listing server 120) related to one or more physical items (e.g., the physical item 106) in the physical environment of the user 104.

The servers 118 and 120 include any type of remote computing system configured to communicate over the network 116 with the computing device 102 and/or to provide information or services to the computing device 102. In an example, the server 118 includes an XR, VR, or AR service provider configured to process images captured by the computing device 102 to generate structure data (e.g., 3D mesh, 3D model, etc.) describing a geometry of one or more physical objects in the physical environment of the user 104. For instance, the server 118 can include a machine learning model operable to estimate depth information from images captured by the computing device 102 and to use the estimated depth information for determining a geometry of the physical item 106 and/or other physical items in the environment of the user 104.

In the illustrated example, the item listing server 120 includes any type of server, server device, computing device, online platform, item gallery, online marketplace, electronic commerce site, and/or any other remote system configurable to list items submitted by the user 104 (and/or other users) to be listed by the listing server 120. For example, the item listing server 120 is configurable as a website, application programming interface (API), cloud storage platform, online market place, and/or any other type of digital platform that the user 104 can log in to (e.g., via the computing device 102 and submit data (e.g., images, models, etc.) related to one or more items to be posted or shared or offered for sale or purchase, and other users similarly accessing the item listing server 120 to view listings of items submitted by the user 104 and/or to post or share items for the user 104 to view. To facilitate this, in the illustrated example, the item listing server 120 includes an item catalog 122 and user account data 124.

The item catalog 122 includes any combination of software or hardware configurable as platform (e.g., e-commerce site, object gallery, etc.) where users can list real-world or physical items for sale and/or purchase real-world or physical objects themselves. A real-world item can be any type of item including, but not limited to, electronics, home goods, automobiles or automotive parts, clothing, musical instruments, art, jewelry, and so forth. In examples, the item catalog 122 includes additional information about the listed items therein, such as data indicating a make, model, type, size, or any other attribute information pertaining to any particular listed item. In another example, the item catalog 122 stores structure data (e.g., 3D model data, 3D mesh data, etc.) indicative of a geometry of a listed item.

The user account data 124 includes data pertaining to specific users of the item listing server 120 (e.g., account user name, password, preferences, etc.). In an example, the user account data 124 includes user data pertaining to the user 104, such as payment methods (e.g., payment card numbers, etc.), mailing addresses, contact information (e.g., telephone numbers), and so forth. This data, for instance, can be used by the user 104 to expedite the process of purchasing or acquiring items listed in the item catalog 122.

In general, functionality, features, and concepts described in relation to the examples above and below are employable in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are configured to be applied together and/or combined in different ways. Thus, individual functionality, features, and concepts described in relation to different example environments, devices, components, figures, and procedures herein are useable in any suitable combinations and are not limited to the combinations represented by the enumerated examples in this description.

### Example Systems and User Interfaces

FIG. 2 depicts a system 200 in an example implementation showing operation of the AR system 114 in greater detail. In the illustrated example, the sensors 110 collect various types of sensor data to facilitate various operations of the computing device 102. In the illustrated example, the sensor data measured by the sensors 110 include image data 204 (e.g., images captured by a camera coupled to the computing device 102). For example, the image data 204 optionally include digital images or videos or other media of a field-of-view of the computing device 102 in the physical environment 212. For example, the image data 204 can include an image of the physical item 106.

In the illustrated example, the sensor data from the sensors 110 includes user input data 206, which are inputs received from the user 104 at the computing device 102 that are measurable by the sensors 110, such as hand gestures, voice commands and other audio inputs, facial expressions, and so forth.

In the illustrated example, sensor data from the sensors 110 optionally includes location data 208, which includes any type of data indicating a position of the computing device 102, such as global positioning system (GPS) measurements, speedometer or accelerometer sensor readings, proximity sensor readings, LIDAR sensor readings, and so forth. By way of example, the location data 208 can be used by the computing device 102 to track movement or position of the computing device 102 and/or the user 104 in the physical environment 212.

In the illustrated example, the sensor data from the sensors 110 also includes user activity data 210. The user activity data 210, for example, includes sensor measurements of a behavior of the user 104. For instance, when the user 104 begins to walk toward or face the physical item 106 to view it, the sensors 110 are configurable to detect this behavior and report it as the user activity 210. Thus, for example, the user activity 210 can be used by the AR system 114 to identify the physical item 106 as a potential item of interest. Other example types of sensors 110 are possible as well, such as any of sensor suitable for XR, AR, and/or VR applications.

As noted earlier, the AR system 114 causes the display 108 to display an AR environment 214 as an augmented reality of the physical environment 212. For example, the augmented reality system 114 is configurable to render a virtual object 216 and optionally a representation (e.g., 3D model) of the physical object 106 so as to simulate an appearance of the physical object 106 and the virtual object 216 in the AR environment 214. In an alternative example, the AR system 114 is configured to render the AR environment 214 by causing the display 108 to project the virtual object 216 into the physical environment 212. Other implementations of the AR environment are possible as well.

In the illustrated example, the AR environment 214 also includes an AR assistant 218. For example, the AR system 114 is operable to render the AR assistant 218 on the display 108 as an interactive virtual object which the user 104 can interact with in the AR environment 214. For instance, the AR assistant 218 is configurable to operate as an interactive virtual character that can move to different locations within the AR environment 214 and/or respond to speech or voice commands from the user 104. Further, in some cases, the AR assistant 218 is operable to assist the user 104 with accessing online service providers like the listing server 120 from within the AR environment 214 in a seamless and intuitive manner. For example, the AR assistant 218 is operable to identify the physical item 106 and/or infer other aspects of the physical environment 212 of the user 104, and then use this knowledge to search for listed items of interest in the listing server 120 in a more effective and intuitive manner than if the user 104 instead submitted a context-unaware search command using a traditional website outside the AR environment 214.

To facilitate the functionalities described above, the AR system 114 in the illustrated example of system 200 includes a game engine 220, a rendering module 222, an object detection module 224, a text-to-speech module 226, a language model 228, and an assistant module 230.

The game engine 220 generally includes one or more software components (e.g., software libraries) configurable to simulate a variety of interactive and/or immersive features that enable the user 104 to seamlessly and intuitively interact with the AR assistant 218 and/or the AR environment 214. For instance, the game engine 220 is configurable to render virtual experiences in the AR environment 214 that emulate the physical environment 212. For example, the game engine 220 optionally includes a physics engine operable to control movement of the AR assistant 218 within the AR environment 214 in a manner that mimics motion of a physical object in a physical environment (e.g., mimic the effect of gravity by keeping the AR assistant 218 close to the ground). As another example, the game engine 220 is operable to implement sound effects to mimic sounds expected from physical actions when the AR assistant 218 simulates performance of the same actions (e.g., knocking on a door or a wall, etc.). Thus, in general, the game engine 220 is configured to provide an immersive experience to the user 104 when the user 104 engages with the AR environment 214 by controlling actions associated with the virtual object 216 and/or the AR assistant 218 in a similar manner as when these actions are instead performed using physical objects.

The rendering module 222 includes any combination of software and hardware components configured to render the virtual object 216 and/or the AR assistant 218 on the display 108. For example, the rendering module 222 is configured to define the graphical appearance and position of the virtual object 216 and/or the AR assistant 218 in the AR environment 214.

The object detection module 224 is configured to identify objects in an image, a 3D model, or other type of digital media using various image processing techniques such as edge detection, depth estimation, and so forth. For example, the AR system 114 is configurable to use the object detection module 224 for identifying the physical item 106 by analyzing the image data 204 of the physical item 106 to infer its geometry or structure. In some example, the object detection module 224 uses the image data to determine structure data (e.g., a 3D mesh or 3D model) or other geometric information of a candidate object in the image data, and then uses other techniques (e.g., machine learning, etc.) to predict an identity of that candidate object. Other functionalities are possible as well.

The text-to-speech module 226 includes any combination of hardware and/or software components operable to process text inputs to provide an audio output corresponding to a pronunciation of the text inputs. For example, the text-to-speech module 226 is operable obtain a text description of a listed item that is related to the physical item 106 (e.g., the description of an accessory) and convert it to speech so that the AR assistant 218 appears to be describing the listed item to the user 104 in the augmented reality environment 214.

Similarly, the language model 228 includes any type of language model, such as a large language model (LLM), a national language model (NLM), or any other computing process that can understand speech from the user 104 and convert the user's speech into a text format or other suitable format. For example, the AR system 114 uses the language model 228 to intuitively understand voice commands from the user 104 when the user 104 is interacting with the AR assistant 218.

The assistant module 230 includes any combination of hardware and software components operable to provide the functions of the AR assistant 218 with respect to the item listing platform 120. By way of example, the assistant module 230 is configured to operate the AR assistant 218 in a first mode (e.g., discovery mode, privacy mode, etc.) when the user 104 is not currently interacting with the AR assistant 218. In the first mode, for example, the AR assistant 218 explores the AR environment 214 to analyze geometric structures (e.g., structure data) that could potentially correspond to a physical item. Through this process, for example, the AR system 114 can use the object detection module 224 to identify a geometric feature in the AR environment 214 (e.g., a 3D mesh of the physical item 106, etc.) and/or other features indicated by the image data 204 as corresponding to a specific physical item 106. Further, in some examples, the assistant module 230 operating in the first mode is configurable to use its knowledge of the identified physical item 106 to proactively search the item listing server 120 for listed items that are related to the identified physical item (e.g., items of the same type that are currently listed for sale at a certain price, or complementary items such as accessories, compatible items like a cup holder listed for sale that matches a cup owned by the user 104, etc.).

As another example, in a second mode of operation (e.g., interactive mode), when the user 104 summons the AR assistant 218, the assistant module 230 uses its knowledge of the identified physical items as well as the information it collected from the listing server 120 to provide intuitive and valuable information to the user 104. For example, if the user 104 summons (e.g., using a voice command) the AR assistant 218 and asks which music records are currently on sale, the assistant module 230 can use its knowledge of other music records (e.g., physical item 106) in the physical environment 212 of the user 104 to recommend listed music records that the user 104 is likely to be interested in (e.g., similar genres, artists, etc. as those that are present in the user's home). Thus, as noted above, the assistant module 230 enables the AR assistant 218 to provide a more effective and intuitive experience tailored for the user 104 to find most relevant information or items for that specific user 104 due to the AR assistant's knowledge of the user's physical environment (e.g., knowledge of similar items in the user's home, etc.).

FIGS. 3-4 illustrate examples 300, 400 of physical and AR environments in which various techniques of the example AR system 114 of FIG. 1 are implemented.

As shown in FIG. 3 for example, the physical environment 212 at the top side of the page includes a plurality of physical items 302, 304, 306. As illustrated in the bottom side of the page, the example 300 shows a scenario where the user 104 uses the computing device 102 to view an augmented reality of the physical environment 212 as the AR environment 214. In this scenario, the AR environment 214 displays to the user 104 a virtual object 216 that indicates a price alert associated with the physical object 302, by overlapping the physical object 302 with the virtual object 216. In this scenario, the assistant module 230 is configured to analyze the AR environment 214 by processing image data 204 and/or structure data determined from the image data 204 in the AR environment 214 (e.g., 3D mesh shape of the region corresponding to the physical item 302) to determine the identity of the physical item 302 as a given type of chair, for example. The assistant module 230 then communicates with the listing server 120 via the communication interface 112, e.g., by sending a search query indicating the identified chair, and receives query results from the listing server 120 indicating information about listed items that are related to the chair 302 (e.g., similar chairs listed for sale in the listing server 120).

Next, in this scenario, the assistant module 230 determines that a price of the listed item corresponding to the chair 302 may be of interest to the user 104. For example, the price of the listed item may have changed recently (e.g., increased or decreased), and so the user 104 may be interested in purchasing the listed item (if the price has become low enough) or may be interested in listing his own chair 302 for sale as well (if the new price has become high enough). In either case, the assistant module 230 alerts the user of this opportunity by causing the rendering module 222 to render the virtual object 216 as shown so that the user 104 can see the alert when he wears the headset 102 and looks at the location of the chair 302 in this augmented reality environment 214.

In an alternative example, the assistant module 230 is configured to delay rendering the virtual object 216 until it detects a user interaction between the AR assistant 218 and the user 104. For instance, the user may be currently busy with another activity and/or less interested in using the listing server 120. Thus, in this alternative example, the assistant module 230 stores the information associated with the price alert until the user 104 begins to interact with the AR assistant 218. For instance, the assistant module 230 could determine that the user 104 triggers a user interaction with the AR assistant 218 if the user performs a hand gesture to summon the AR assistant 218 (e.g., input data 206 indicates a hand gesture which triggers the AR system 114 to render the virtual object 216), or if the user 104 walks toward the chair 302 and begins to inspect it (e.g., user activity 210 triggers outputting the virtual object 216).

In the example 400 scenario at the top of the page, the user 104 interacts with the AR assistant 218 by calling its name “Fred” and asking a question using natural human speech (e.g., “is there anything interesting the e-commerce site today?”). The AR system 114 then uses the language model 228 to understand the users question. The AR system 114 also uses the rendering module 222 and game engine 220 to move the AR assistant 218 closer to the user 104, for example, to provide a realistic and personal experience to the user 104, which would not be possible if the user 104 was using a conventional website page out of the AR environment 214. Further, in this scenario, the AR system 114 uses its prior knowledge of identified physical items in the AR environment 214, such as the rug on the floor, and his knowledge of prior user behavior specific to the user 104 (e.g., the user was recently browsing the listing server 120 for a certain rug that now has a lower price), to quickly generate an intuitive response (e.g., using text-to-speech module 226) in an interactive and natural manner (e.g., informing the user 104 that the rug of interest is on is on sale and asking him if he wants to purchase it). Next, in this scenario, the user 104 again provides instructions in a natural speech format to the AR assistant 218, which requires the AR assistant 218 to know information specific to the user 104 (e.g., card number and office address), which the AR system 114 quickly interprets by using the language model 228. In this scenario, the AR system 114 then uses the communication interface 112 to provide the order details to the listing server (e.g., including the user's choice of payment method and shipping address), and then confirms to the user 104 that the transaction was successfully completed.

Continuing with the example 400, in the scenario at the bottom of the page, the AR system 114 draws the attention of the user 104 to an issue in the AR environment 214 by positioning the AR assistant 218 near a structural feature that the AR system 114 was unable to identify. For instance, in this scenario, the AR system 114 may be unable to identify a make or model of the television or physical item 304 due to insufficient image data 210 and/or structure data in the 3D mesh of the AR environment 214 of this scenario. In turn, for instance, the AR assistant 218 moves to the unrecognized feature hanging on the wall and produces speech output (e.g., using text-to-speech module 226) in a natural speech format (e.g., using the language model 228) to request from the user 104 that he capture additional image data 204 of the physical item 304 so that the AR system 114 can identify or recognize it. Accordingly, as illustrated with the above-described example scenarios 300 and 400, the techniques of the present disclosure provide a significantly improved and intuitive user interface (i.e., the AR environment 214 and the AR assistant 218) for accessing the item listing service provider 120 as compared to traditional website user interfaces.

### Example Procedures

The following discussion describes techniques that are configured to be implemented utilizing the previously described systems and devices. Aspects of each of the procedures are configured for implementation in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-3.

FIG. 5 depicts a procedure 500 in an example implementation of an augmented reality system that is configured to provide an interactive augmented reality assistant for accessing an item listing service. To begin, the computing device 102 captures image data 204 of a physical environment 212 to facilitate displaying an augmented reality of the physical environment 212 as an augmented reality environment 214 (block 502).

The assistant module 230 or the AR system 114 then uses the image data 204 to identify the physical item 106 (block 504). For example, the AR system 114 processes the image data 204 to estimate structure data that indicates a structure or geometry of surfaces of objects in the image data 204, such as the geometry of physical item 106 (block 506).

The assistant module 230 then communicates with the listing server 120 to identify a listed item related to the physical item 106 (block 508). For example, the assistant module 230 can use the communication interface 112 to communicate a search query for searching the item catalog 122 to the listing server 120 over the network 116. The listing server 120, in turn, returns search query results that include an indication of one or more listed items (i.e., items listed in the item catalog 122) that are related to the physical item 106.

The rendering module 222 renders an AR assistant 218 for accessing the listing platform 120 (block 510). For example, the game engine 220 and/or the rendering module 222 cause the display 108 to display a graphic object controlled to behave like an interactive character.

In response to detecting a user interaction with the AR assistant 218, the assistant module 230 generates an output using information associated with the listed item (block 512). For example, in the scenario of FIG. 4 (top of page), the user 104 interacts with the AR assistant 218 by calling its name (“Fred”) and asking a question. In an example, the AR system 114 generates the output using a large language model 228 (block 514). Continuing with the scenario of FIG. 4, the AR system 114 generates an audio output as speech by the AR assistant 218 that responds to the user's question. Alternatively or additionally, the AR system 114 generates the output by rendering the information for display in the AR environment 214. For example, the AR system 114 generates the virtual object 216 including an alert about the price for display in the AR environment 214.

In some examples the computing device 102 detect, using one or more sensors 110, that the user 104 of the computing device 102 is viewing an item of the one or more physical items. For example, in the scenario at the bottom of the page of FIG. 3, the computing device 102 detects (using the sensors 110) that the user 104 is currently viewing the physical item 302. In these examples, the computing device 102 selects the information (e.g., price alert in virtual object 216) that is to be output in the AR environment 214 from data (e.g., the data obtained from the image catalog 122 corresponding to the physical items 302, 304, and 306) associated with the one or more listed items based on the information (e.g., price alert depicted in the virtual object 216) corresponding to a listed item that is related to the viewed item (e.g., the physical item 302).

Having described example procedures in accordance with one or more implementations, consider now an example system and device to implement the various techniques described herein.

### Example System and Device

FIG. 6 illustrates an example system 600 that includes an example computing device 602, which is representative of one or more computing systems and/or devices that implement the various techniques described herein. This is illustrated through inclusion of the AR system 114. The computing device 602 is configured, for example, as a service provider server, as a device associated with a client (e.g., a client device), as an on-chip system, and/or as any other suitable computing device or computing system.

The example computing device 602 as illustrated includes a processing system 604, one or more computer-readable media 606, and one or more I/O interface 608 that are communicatively coupled, one to another. Although not shown, the computing device 602 is further configured to include a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that are configurable as processors, functional blocks, and so forth. For instance, hardware element 610 is implemented in hardware as an application specific integrated circuit or other logic device formed using one or more semiconductors. The hardware elements 610 are not limited by the materials from which they are formed, or the processing mechanisms employed therein. For example, processors are alternatively or additionally comprised of semiconductor(s) and/or transistors (e.g., electronic integrated circuits (ICs)). In such a context, processor-executable instructions are electronically executable instructions.

The computer-readable storage media 606 is illustrated as including memory/storage 612. The memory/storage 612 represents memory/storage capacity associated with one or more computer-readable media. The memory/storage 612 is representative of volatile media (such as random-access memory (RAM)) and/or nonvolatile media (such as read only memory (ROM), Flash memory, optical disks, magnetic disks, and so forth). The memory/storage 612 is configured to include fixed media (e.g., RAM, ROM, a fixed hard drive, and so on) as well as removable media (e.g., Flash memory, a removable hard drive, an optical disc, and so forth). In certain implementations, the computer-readable media 606 is configured in a variety of other ways as further described below.

Input/output interface(s) 608 are representative of functionality to allow a user to enter commands and information to computing device 602 and allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., a device configured to employ visible or non-visible wavelengths such as infrared frequencies to identify movement as gestures that do not involve touch), and so forth. Examples of output devices include a display device (e.g., a monitor or projector), speakers, a printer, a network card, tactile-response device, and so forth. Thus, the computing device 602 is representative of a variety of hardware configurations as further described below to support user interaction.

Various techniques are described herein in the general context of software, hardware elements, or program modules. Generally, such modules include routines, programs, objects, elements, components, data structures, and so forth that perform particular tasks or implement particular data types. The terms “module,” “functionality,” and “component” as used herein generally represent software, firmware, hardware, or a combination thereof. The features of the techniques described herein are platform-independent, meaning that the techniques are configured for implementation on a variety of commercial computing platforms having a variety of processors.

An implementation of the described modules and techniques are stored on or transmitted across some form of computer-readable media. The computer-readable media include a variety of media that is accessible by the computing device 602. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information for access by a computer.

“Computer-readable signal media” refers to a signal-bearing medium that is configured to transmit instructions to the hardware of the computing device 602, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that is employed in some embodiments to implement at least some aspects of the techniques described herein, such as to perform one or more instructions. Hardware, in certain implementations, includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are employed to implement various techniques described herein. Accordingly, software, hardware, or executable modules are implemented as one or more instructions and/or logic embodied on some form of computer-readable storage media and/or by one or more hardware elements 610. The computing device 602 is configured to implement instructions and/or functions corresponding to the software and/or hardware modules. Accordingly, implementation of a module that is executable by the computing device 602 as software is achieved at least partially in hardware, e.g., through use of computer-readable storage media and/or hardware elements 610 of the processing system 604. The instructions and/or functions are executable/operable by one or more articles of manufacture (for example, one or more computing devices 602 and/or processing systems 604) to implement techniques, modules, and examples described herein.

The techniques described herein are supported by various configurations of the computing device 602 and are not limited to the specific examples of the techniques described herein. This functionality is further configured to be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 include applications and/or data that is utilized while computer processing is executed on servers that are remote from the computing device 602. Resources 618 also include services provided over the Internet and/or through a subscriber network, such as a cellular or Wi-Fi network.

The platform 616 is configured to abstract resources and functions to connect the computing device 602 with other computing devices. The platform 616 is further configured to abstract scaling of resources to provide a corresponding level of scale to encountered demand for the resources 618 that are implemented via the platform 616. Accordingly, in an interconnected device embodiment, implementation of functionality described herein is configured for distribution throughout the system 600. For example, in some configurations the functionality is implemented in part on the computing device 602 as well as via the platform 616 that abstracts the functionality of the cloud 614.

### Conclusion

Although the invention has been described in language specific to structural features and/or methodological acts, the invention defined in the appended claims is not necessarily limited to the specific features or acts described. Rather, the specific features and acts are disclosed as example forms of implementing the claimed invention.

What is claimed is:

1. A method comprising:
capturing, by a computing device, image data of a physical environment for displaying an augmented reality (AR) of the physical environment as an AR environment;
identifying one or more physical items in the physical environment based at least in part on the image data;
communicating with one or more listing servers over a network to identify one or more listed items related to the one or more physical items;
rendering a virtual object in the AR environment as an AR assistant for accessing the one or more listing servers; and
responsive to detecting a user interaction with the AR assistant in the AR environment, generating an output using information associated with the one or more listed items.

2. The method of claim 1, wherein generating the output comprises using a large language model to generate an audio output indicative of the information.

3. The method of claim 1, wherein generating the output includes rendering the information for display in the AR environment.

4. The method of claim 3, wherein rendering the information includes rendering at least one of the one or more listed items in the AR environment.

5. The method of claim 3, further comprising positioning the rendered information in the AR environment according to a location of at least one of the one or more physical items in the physical environment.

6. The method of claim 1, further comprising:
detecting, using one or more sensors, that a user of the computing device is viewing an item of the one or more physical items; and
selecting the information from data associated with the one or more listed items based on the information corresponding to a listed item that is related to the viewed item.

7. The method of claim 1, further comprising:
identifying the one or more physical objects based on structure data determined from the image data that indicates a geometry of the one or more physical objects.

8. The method of claim 1, further comprising detecting the user interaction by detecting a hand gesture using one or more sensors of the computing device.

9. The method of claim 1, further comprising detecting the user interaction by receiving audio input indicative of a voice command for the AR assistant and using a large language model to generate text indicative of the voice command.

10. The method of claim 1, further comprising:
determining, by the computing device, that a physical item of the one or more physical item corresponds to a listed item that is listed in the one or more listing servers for sale at a lower price than the physical item; and
responsive to the determining, displaying a notification to the user in the AR environment that includes an indication of the price of the physical item and a price of the listed item.

11. A system comprising:
at least one memory; and
at least one processor coupled with the at least one memory, the at least one memory storing computer-readable instructions that, when executed by the at least one processor, cause the system to perform operations comprising:
capturing image data of a physical environment for displaying an augmented reality (AR) of the physical environment on a display as an AR environment;
identifying one or more physical items in the physical environment from the image data;
communicating with one or more listing servers over a network to identify one or more listed items related to the one or more physical items;
rendering a virtual object as an AR assistant for display in the AR environment; and
responsive to detecting a user interaction with the AR assistant in the AR environment, generating an output using information associated with the one or more listed items.

12. The system of claim 11, wherein generating the output comprises using a large language model to generate an audio output indicative of the information.

13. The system of claim 11, wherein generating the output includes rendering the information for display in the AR environment.

14. The system of claim 13, wherein rendering the information includes rendering at least one of the one or more listed items in the AR environment.

15. The system of claim 13, the operations further comprising:
positioning the rendered information in the AR environment according to a location of at least one of the one or more physical items in the physical environment.

16. The system of claim 11, the operations further comprising:
detecting, using one or more sensors, that a user of the system is viewing an item of the one or more physical items; and
selecting the information from data associated with the one or more listed items based on the information corresponding to a listed item that is related to the viewed item.

17. The system of claim 11, the operations further comprising:
identifying the one or more physical objects based on structure data determined from the image data that indicates a geometry of the one or more physical objects.

18. The system of claim 11, the operations further comprising:
detecting the user interaction by detecting a hand gesture using one or more sensors of the system.

19. The system of claim 11, the operations further comprising:
detecting the user interaction by receiving audio input indicative of a voice command for the AR assistant and using a large language model to generate text indicative of the voice command.

20. A computing device, comprising:
a display configured to display an augmented reality (AR) of a physical environment as an AR environment;
a sensor configured to capture image data of the physical environment;
at least one processor;
at least one memory storing instructions that, when executed by the at least one processor, cause the computing device to:
identify one or more physical items in the physical environment based at least in part on the image data;
communicate with one or more listing servers over a network to identify one or more listed items related to the one or more physical items;
render a virtual object in the AR environment as an AR assistant for accessing the one or more listing servers; and
responsive to detecting a user interaction with the AR assistant in the AR environment, generate an output using information associated with the one or more listed items.
